(19) United States
(12) Patent Application Publication
(10) Pub. No.: US 2011/0012902 A1
(43) Pub. Date: Jan. 20, 2011

(54) METHOD AND SYSTEM FOR VISUALIZING THE PERFORMANCE OF APPLICATIONS

(76) Inventors: Jaganathan Rajagopalan, Bangalore (IN); Medhi Goranka, Guwahati (IN); Frank Vosseler, Altdorf (DE); Martin Bosler, Wannweil (DE); Martin Tischhäuser, Wildberg (DE); TL Sudhindra Kumar, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/504,419

(22) Filed: Jul. 16, 2009

(51) Int. Cl. G06T 11/20; G06F 15/177; G06F 17/00

(52) U.S. Cl. 345/440; 715/735; 715/736; 707/E17.012

(57) ABSTRACT

An exemplary embodiment of the present invention provides a method for visualizing the performance of a system. The method includes generating a topological map of an application environment from a configuration management database (CMDB), wherein the topological map comprises a plurality of configuration items (CIs). A selection of configuration items (CIs) is made from the plurality of CIs. The definition of one or more performance graph(s) for the CIs is obtained from an operational database, wherein the performance graphs are configured to simultaneously show performance metrics for the CI and related CIs. Performance data for the CI and the related CIs are accessed and the performance graph is generated from the data.

### BACKGROUND

Computing infrastructures have significantly advanced in complexity over single processor user systems. Enterprise applications having complex multi-processor and multi-system configurations have become common. Often, applications run on these systems may be multi-tiered virtual applications that may belong to numerous isolated entities, such as individual companies that have contracted for processing power in a cloud computing environment. Accordingly, diagnosing performance degradations that may be caused by hardware, software, or communications infrastructure may be challenging.

### BRIEF DESCRIPTION OF THE DRAWINGS

Certain exemplary embodiments are described in the following detailed description and in reference to the drawings, in which:

FIG. 1 is a block diagram illustrating a multi-user, multi-system network for running network applications, in accordance with exemplary embodiments of the present invention;

FIG. 2 is a screen shot of a topological map of a simplified J2EE application that may run on the system of FIG. 1, in accordance with exemplary embodiments of the present invention;

FIG. 3 is a screenshot illustrating a set of performance graphics for following the operation of the application topology of FIG. 2, in accordance with exemplary embodiments of the present invention;

FIG. 4 is a block diagram of a graphical diagnostic system, in accordance with exemplary embodiments of the present invention;

FIG. 5 is a block diagram of a method for tracking the performance of a system using a graphical diagnostic tool, in accordance with exemplary embodiments of the present invention;

FIG. 6 is a block diagram illustrating a three tiered application environment showing a performance degradation that may be diagnosed, in accordance with exemplary embodiments of the present invention;

FIG. 7 is a screenshot illustrating the visualization of metrics based on configuration item (CI) type, in accordance with exemplary embodiments of the present invention;

FIG. 8 is a screenshot illustrating the visualization of metrics based on CI, in accordance with exemplary embodiments of the present invention;

FIG. 9 is a screenshot illustrating the visualization of a single metric across multiple CIs, in accordance with exemplary embodiments of the present invention; and

FIG. 10 is a screenshot illustrating the visualization of all of the metrics, in accordance with an exemplary embodiment of the present invention.

### DETAILED DESCRIPTION OF SPECIFIC EMBODIMENTS

Tools for diagnosing performance degradation have generally focused on either the computing system or the application. The system tools have focused on the operation of the hardware, for example, in a network or cluster, allowing for the diagnosis of hardware faults, such as disk failures, memory failures, and the like. Application tools have generally focused on single applications, such as a database, focusing on cluster usage, data transmission rates, and the like.

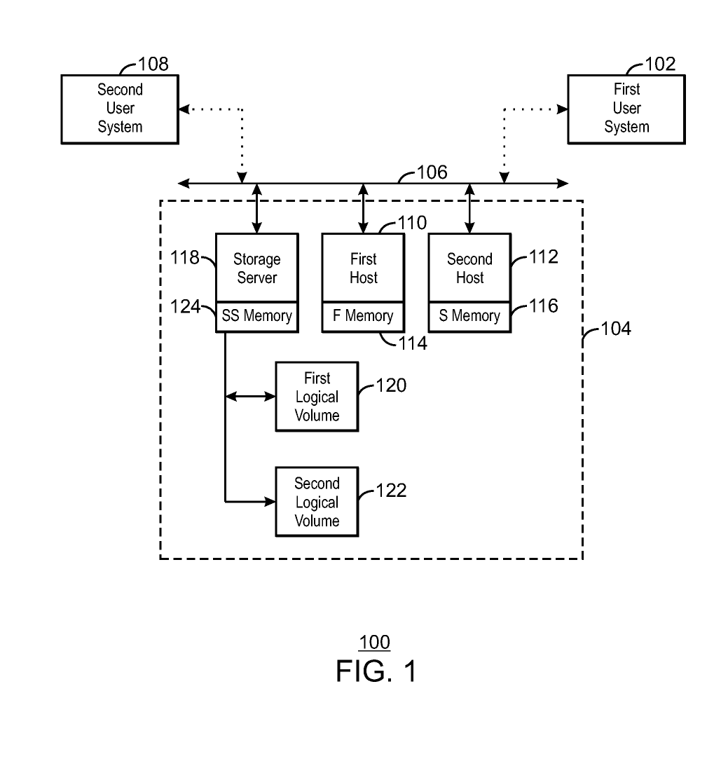

Exemplary embodiments of the present invention are directed to a graphical diagnostic method and system that makes use of a topology model generated from a configuration management database system (CMDB). The topology model in the CMDB allows the graphical presentation of information to be dynamic in nature, for example, by the launching of performance graphs across both application and system tiers based on the configuration item (CI) relationships read from the CMDB. Thus, a user can be provided with correlated metrics from related applications and operating system services. Further, the graphs adapt to the current network and application conformation by taking into account the changes to the topology when items are added or removed from the network. The methods and systems provide a dynamic performance tracking system for both application and hardware environments, such as those portrayed in FIG. 1.

FIG. 1 is a block diagram illustrating a multi-user, multi-system network 100 for running network applications, in accordance with exemplary embodiments of the present invention. As illustrated in FIG. 1, a first user system 102 can communicate with an application environment 104 over a network 106, such as a local area network (LAN), a wide area network (WAN), the Internet, or any other network connections. Other user systems may also be communicating with the application environment 104 over the network 106, such as a second user system 108.

The application environment 104 can be configured with any number of units to provide functionality. For example, the application environment 104 can have one or more host systems, such as a first host 110 and a second host 112. The host systems 110 and 112 may be single processor systems or may be multi-processor clusters. Each host system 110 and 112 can contain a tangible, machine readable medium, such as an F memory 114 or an S memory 116, to store applications, process threads, data, results, and the like. The machine readable medium may include random access memory (RAM), read-only memory (ROM), flash drives, hard drive, an array of hard drives, optical drives, an array of optical drives, and the like. The host systems may provide processing power to application programs or processes, such as a database program, a Java Enterprise Edition (J2EE) process, a graphics processing program, or any number of other processes either alone or in combinations. Although two hosts systems are shown in FIG. 1, any desirable number of host systems may be included in the application environment 104. For example, a single host system operating an associated storage unit for data storage may be selected for a simple application environment 104, while a complex exemplary embodiment of the application environment 104 may have tens to hundreds of host servers.

Further, the application environment 104 can have associated storage units for storing application data, such as the records in a database or the images for a complex graphics calculation. For example, the application environment 104 can have a storage server 118 that manages logical volumes, such as a first logical volume 120 and a second logical volume 122. The logical volumes 120 and 122 may be partitions on a single hard drive, or may be separate hard disk drives, arrays of hard disk drives, optical drives, arrays of optical drives, and the like.

As for the hosts, the storage server 118 may have a tangible, machine readable medium (such as an SS memory 124) for storing applications, processes, data, communications threads, and the like. The storage server 118 may also store data on the logical volumes 120 and 122. Although a single storage server 118 is shown, a simple exemplary embodiment of the application environment 104 may not need any extra storage, as the storage may be handled by a host. Conversely, a complex application environment 104, such as a service provider located on the Internet, may have tens or hundreds of storage servers for each host.

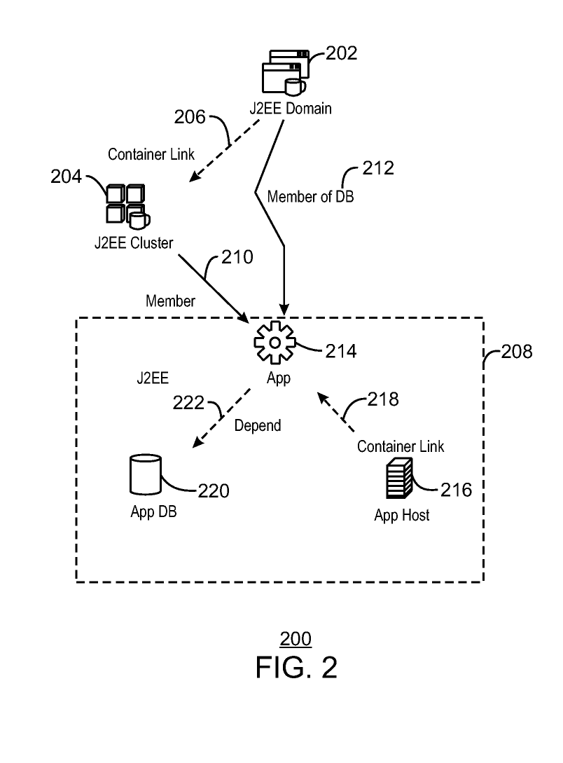

As shown in FIG. 1, the first host 110, the second host 112, and the storage server 118 may communicate over the network connection 106, which is coupled to the user systems 102 and 108. In addition to the network connection 106 that is coupled to the user systems 102 and 108, the application environment 104 may have one or more separate networks for communication between the computing units. These separate networks may be internal to the application environment 104, external to the application environment 104, or both. The application environment 104 described with respect to FIG. 1 may support any number of potential applications, such as the J2EE application illustrated in FIG. 2.

FIG. 2 is a screen shot of a topological map 200 of a simplified J2EE application that may run on the system of FIG. 1, in accordance with exemplary embodiments of the present invention. The J2EE application generally exists in a J2EE domain 202 which contains a J2EE cluster 204, as indicated by a container link 206. The J2EE cluster 204 has the J2EE application environment 208 as a member, as indicated by a member link 210. The J2EE domain 202 also contains the J2EE application environment 208 as a member of the database for the J2EE Domain 202, as indicated by the link 212 labeled as “Member of DB.” The J2EE application environment 208 contains the application 214, which could be an accounting program, a graphics calculation program, a database program, or any number of other programs. The application 214 may be contained in an application host 216 as indicated by the container link 218 from the application host 216. The application host 216 may correspond to one of the hosts 110 or 112, discussed with respect to FIG. 1. In another exemplary embodiment, the application host 216 may correspond to one or more virtual hosts which are operating on a cluster of physical machines. The application environment is not limited to a J2EE system. In exemplary embodiments of the present invention other application software environments may be used, such as Microsoft® Windows DNA (Distributed Network Architecture).

The application 214 depends on data from an application database 220, as indicated by a depend link 222. The application database 220 may be a separate physical unit, such as the storage server 118, discussed with respect to FIG. 1. In other exemplary embodiment, the application database 220 may be contained within the physical or virtual application host 216. All of the items shown in FIG. 2 (such as the application 214, the J2EE domain 202, and the application host 216) will be individual CIs that are contained in a CMDB. Thus, the topographical map 200 may be generated from the CMDB and may include hardware components, software modules, or both. Further, in exemplary embodiments of the present invention, modifications of the underlying topology, such as adding or removing items, will automatically be reflected in the topological map 200.

As discussed in further detail below, in exemplary embodiments, performance graphs can be generated for any element that is modeled in the CMDB as a set of different CIs with relationships, for example, business service application, software elements, infrastructure elements, and hardware, among many others. If CIs are added or removed, the performance graphs for those CIs (and the performance graph definitions for the associated CIType) will also change. Further, the topological map may also be manually or automatically updated to reflect changes in relationships between CIs. These changes in relationships may also be reflected in the performance graph definitions for the CITypes, for example, by adding performance metrics for newly related CIs or removing performance metrics when CIs are no longer related.

Those of ordinary skill in the art will appreciate that the J2EE application may be more complex than the example shown in the topological map 200 of FIG. 2. However, even for the simple system illustrated in FIG. 2, the number of different containers, interactions, and dependencies provide a large number of possible performance metrics (such as dimensions), which complicates performance visualization. Generally, as persons are adapted to visualizing 4-dimensional space (x, y, z, and time) it may be difficult to visualize more than four metrics simultaneously. Exemplary embodiments of the present invention address this issue by logically dividing the large number of performance metrics among separate graphs, at least in part on the basis of the selection of a user, the application topology and the problem to be analyzed. Accordingly, a user could select a specific unit (a target CI, such as the application 214) from the topological map 200, and see performance graphs for related units (for example, hardware or software CIs that provide resources to the target CI). These performance graphs could present not only the information that is directly related to the application 214 itself, but also related to supporting hardware and software modules, such as the application host 216 or the application database 220, among others.

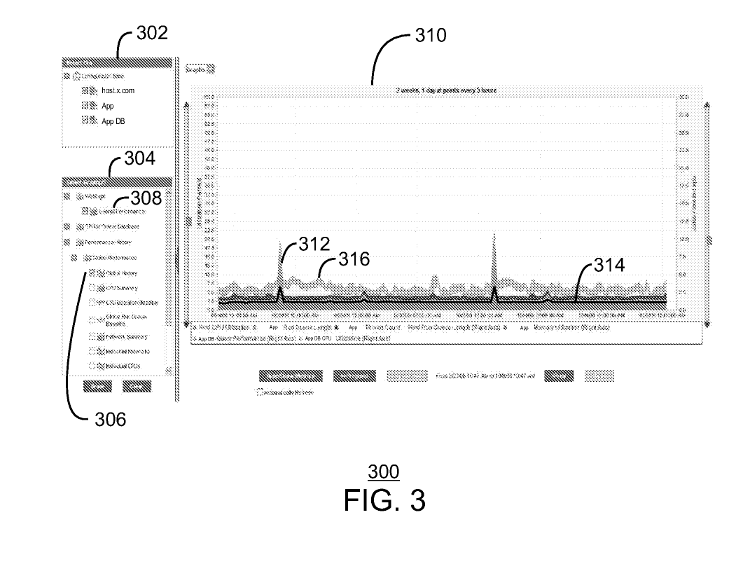

FIG. 3 is a screenshot illustrating a set of performance graphics 300 for following the operation of the application topology of FIG. 2, in accordance with exemplary embodiments of the present invention. As indicated in a Select CIs box 302, a user has chosen to visualize the performance of CIs at all three tiers of an application, such as a host, an application, and an application database. Further, as indicated in a Select Graph(s) box 304, the user has chosen to display a global history graph 306 and Overall Performance graph 308 of the CIs selected. In response to these selections, an exemplary embodiment of the present invention displays a graph box 310, which displays a graph of such metrics as CPU utilization 312, database application CPU utilization 314, and memory utilization 316, among others.

A topology based performance graph may generally display metrics from multiple hosts for all CIs that are closely related to a problem. These metrics may be termed the “golden metrics,” as they may be most related to diagnosing the problem. Further, increasing the number of metrics and relevant CIs in the graph may improve the chances of identifying performance bottlenecks. Accordingly, the graphic visualization in exemplary embodiments of the present invention displays relative performance and comparative values with respect to real word entities like CI type (such as the database tier) and the CI instance (such as the application host).

However, in larger systems visualization of large numbers of performance metrics to analyze a problem may be challenging. In exemplary embodiments, a “view” and “filter” based approach is used to visualize a large number of performance metrics at the same time, generally by contextually binding the metrics into multiple graphs. As humans generally visualize information more efficiently as relative values rather than as absolute values, this provides a good match between the visual output of the system and the visual input of a user, improving the efficiency of performance tracking and problem diagnosis.

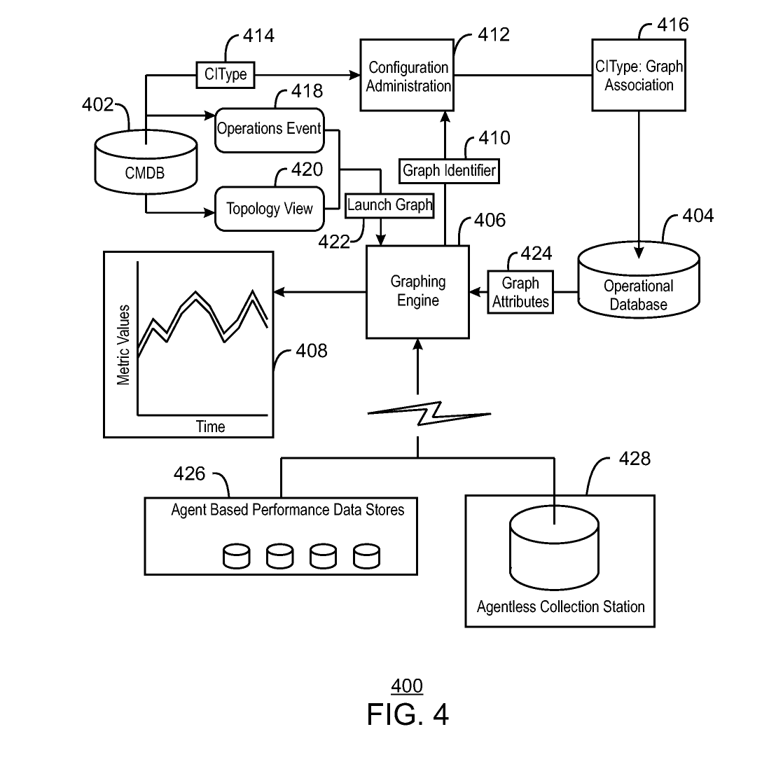

FIG. 4 is a block diagram of a graphical diagnostic system 400, in accordance with exemplary embodiments of the present invention. Each of the blocks of the system 400 may be software, hardware, or a combination of hardware and software. The system 400 is associated with a CMDB 402, which is automatically updated as configuration items (including hardware and software) are added, removed, or modified. The CMDB 402 is organized by configuration item types (CITypes) that form the basis of the topological maps. The system 400 also has an operational database 404 that stores the basic operational data, such as graph attributes, CI type association with particular graph attributes, neighborhood definitions, and the like.

A graphing engine 406 is the core operational unit of the system 400, and is used to define one or more graphs 408 and to access information to generate the graphs 408. For example, a new graph 408 can be created and displayed using the graphing engine 406 in a direct operational mode. The graphing engine 406 generates a graph identifier 410 that is associated with the new graph 408 and passes it on to a configuration administration module 412. The configuration administration module 412 obtains a CIType identifier 414 from the CMDB 402, creates a CIType:graph association 416 of the graph identifier 410 with the CIType identifier 414, and saves both the graph attributes and the association 416 in the operational database 404. The configuration administration module 412 also allows users to manually create or modify the association 416 between graphs 408 and the CITypes 414.

When a graph definition is deleted from the operational database 404 or a CIType 414 is deleted from the CMDB 402, the relevant CIType:graph associations 416 are also removed from the operational database 404. Generally, changes made to the topology model do not impact the association 416, since the associations 416 are stored in the operational database 404. However, the graph definitions and associations 416 may be automatically updated based on the changes to the CMDB 402. For example, if an application server is changed from a WebLogic system (from Oracle®) to a WebSphere® system (from IBM®), the CMDB 402 would be automatically updated. Accordingly, the graphing engine 406 would use the relevant graph definitions for the new application server (for example, WebSphere®) to provide a basis for obtaining the performance data.

The graph 408 can be launched by an operations event 418 or by a selection from a topology view 420. For example, the system 400 may be configured to launch a graph 408 if memory utilization reaches a problematic level. A launch graph command 422 to launch the graph 408 is passed to the graphing engine 406. The CI associated with the event or the selection and the related neighborhood CIs are identified by the graphing engine 406 from the topology model contained in the CMDB 402. Based on the CI types 414 for these CIs, the corresponding graph attributes 424 are loaded from the operations database 404 by the graphing engine 406.

The graphing engine 406 can then connect to the relevant hosts containing the performance data stores for the impacted CIs. For example, the data used to generate the graph may be stored in agent based performance data stores 426, an agentless collection station 428, or both. The graphing engine 406 fetches data for the golden metrics defined in the graph attributes 424 and generates one or more performance graphs 416.

In an exemplary embodiment, the performance graphs 416 are shown to a performance expert along with a tree view of the impacted CIs and related graph attributes 424. The performance expert can then modify the CI and graph selections to generate more graphs to drill down further and analyze the problem. Performance analysis and troubleshooting of applications and the system infrastructure they are hosted on is based on relations between these CIs as discovered and stored in the CMDB 402. This approach improves correlation and diagnosis of performance bottlenecks across the tiers in a tiered application, such as the application tier, the database tier, or the host tier.

In an exemplary embodiment of the present invention, automatic updating of the CMDB 402 and the discovery of the topology model from the CMDB 402 by the graphing engine 406 generally ensures that if the CMDB changes, the graphing engine 406 will use the new topology model without the need for manual intervention.

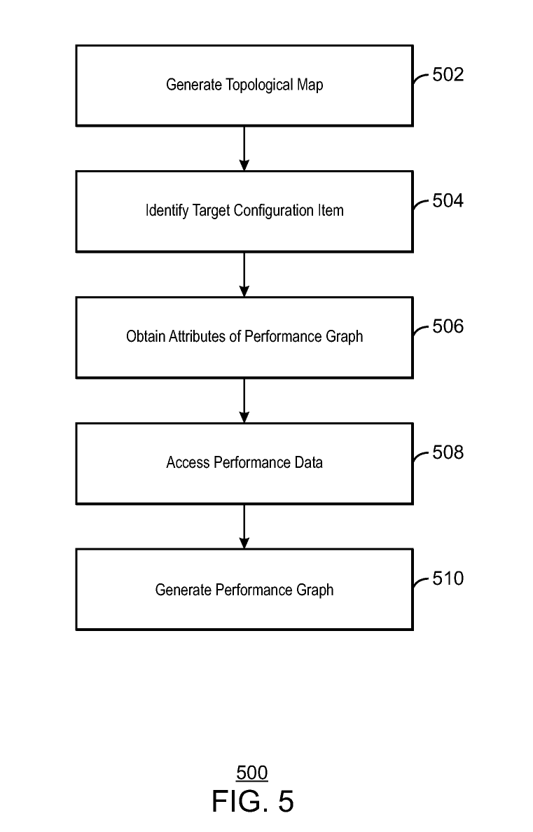

FIG. 5 is a block diagram of a method 500 for tracking the performance of a system using a graphical diagnostic tool, in accordance with exemplary embodiments of the present invention. The method 500 begins at block 502 with the generation of a topological map of the application environment from the CMDB. The topological map may include all of the CIs that perform functions in the application, include hardware, software, or virtual units. At block 504, a target CI is identified for the generation of performance graphs. The target CI may be identified by a user selection from a list or topological map of the system, or may be automatically identified when a problem occurs. A CIType may then be identified for the target CI from the CMDB. At block 506, the graphing engine accesses the graph attributes that correspond to the CIType from the operational database, including the default set of golden metrics. At block 508, the graphing engine accesses the data from the performance data stores for these CIs. At block 510, the performance data is used by the graphing engine to generate the performance graph for the CIs. Once the graphs are drawn by the system and available to the user, the user may be presented with a tree view that contains participating CIs and all available graph definitions for these CIs. A user can then choose to select or de-select CIs or graph definitions and regenerate the graphs.

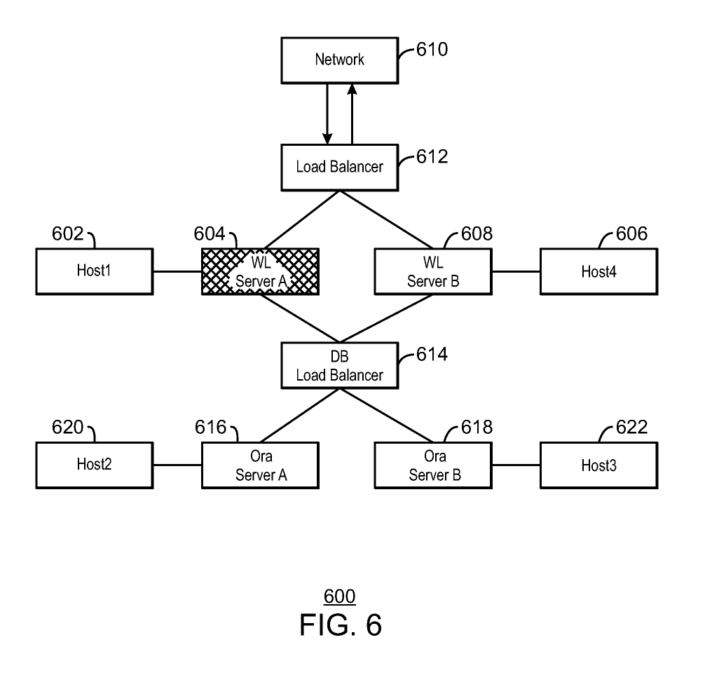

In exemplary embodiments of the present invention, the user has the option to create new or modified graph definitions, mark the set of golden metrics within and associate them with CI types. This capability provides the ability to create and refine templates and corresponding associations, and, thus, build performance diagnostics that can be reused across an enterprise. Further, in an exemplary embodiment of the present invention, the user is not limited to displaying performance graphs related to a single CI. More specifically, filtered views that allow the graphing of performance metrics from similar CI types, or all CIs hosted on a particular system, are described with respect to FIGS. 6-10.

FIG. 6 is a block diagram 600 illustrating a three tiered application environment showing a performance degradation that may be diagnosed by exemplary embodiments of the present invention. In the block diagram 600, four host systems are used to provide functionality to a multi-tiered application. Host1 602 operates a first WebLogic server environment, WL Server A 604. Host4 606 operates a second WebLogic server environment, WL Server B 608. The servers 604 and 608 generally communicate with users on a network 610 through a load balancer 612. The load balancer 612 determines which of the WL servers 604 or 608 to send packets based on the loading (for example, as measured by the response speed) of the WL servers 604 or 608.

The WL servers 604 and 608 may operate an application that uses a DB load balancer 614 to communicate with Oracle® servers, Ora server A 616 and Ora server B 618. Ora server A 616 is operated by Host2 620, while Ora server B 618 is operated by Host3 622. Each of these items are CIs that would generally be listed in the CMDB for the system. The configuration detailed above may provide a substantial number of possible performance metrics. For example, if the default performance metrics for the CIs include three measurements for each system at each tier (for example, the WebLogic servers, the Oracle® servers, and the hosts), then 18 metrics may be available for graphing. As will be understood by those of ordinary skill in the art, many more performance metrics may be possible, depending on the number of related or neighborhood CIs and the number of default metrics for each CI.

In FIG. 6, WL server A 604, running on Host1 602, may show performance degradation, such as a decrease in the number of packets it will accept from the load balancer 612. In an exemplary embodiment of the present invention, a performance graph may be launched (manually or automatically) to diagnose the problem. The simplest way to visualize the metrics would be to draw them in single graph, with each legend name indicating the associated CI and host for each metric, as illustrated in FIG. 3. However, the significant number of metrics to be graphed may make a single graph difficult to analyze.

In exemplary embodiment of the present invention, “views” and “filters” may be used to visualize performance metrics in the context of topology. This may provide faster troubleshooting of performance related issues. The views and filters may help in analyzing the problem globally from topology perspective and then drilling down to identify bottlenecks in specific metric(s) related to a CI.

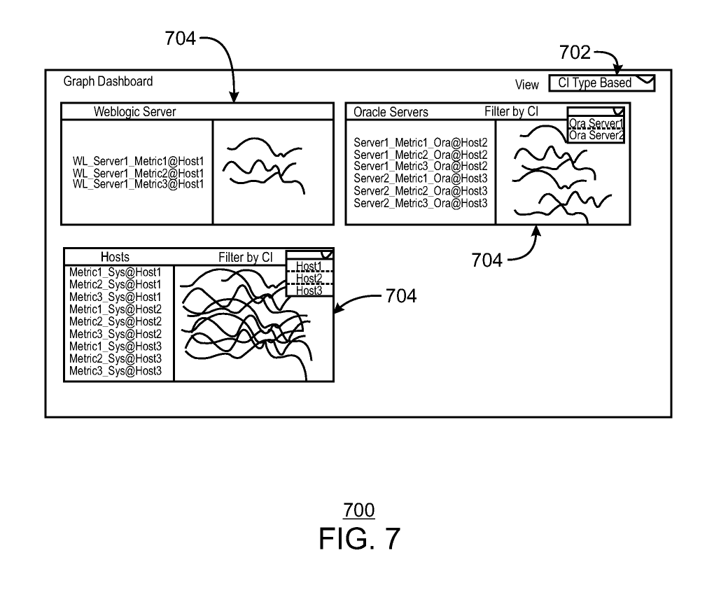

FIG. 7 is a screenshot 700 illustrating the visualization of metrics based on CI type 702, in accordance with exemplary embodiments of the present invention. This view may help in isolating the application tier (web server, app server, database tier or the like) that is associated with a performance degradation by displaying separate graph for each tier (such as a single CI type). Each graph 704 gives a global picture of an application tier by displaying metrics from all CIs of corresponding CI type (for example, Ora Server1 and Ora Server2 in the DB tier).

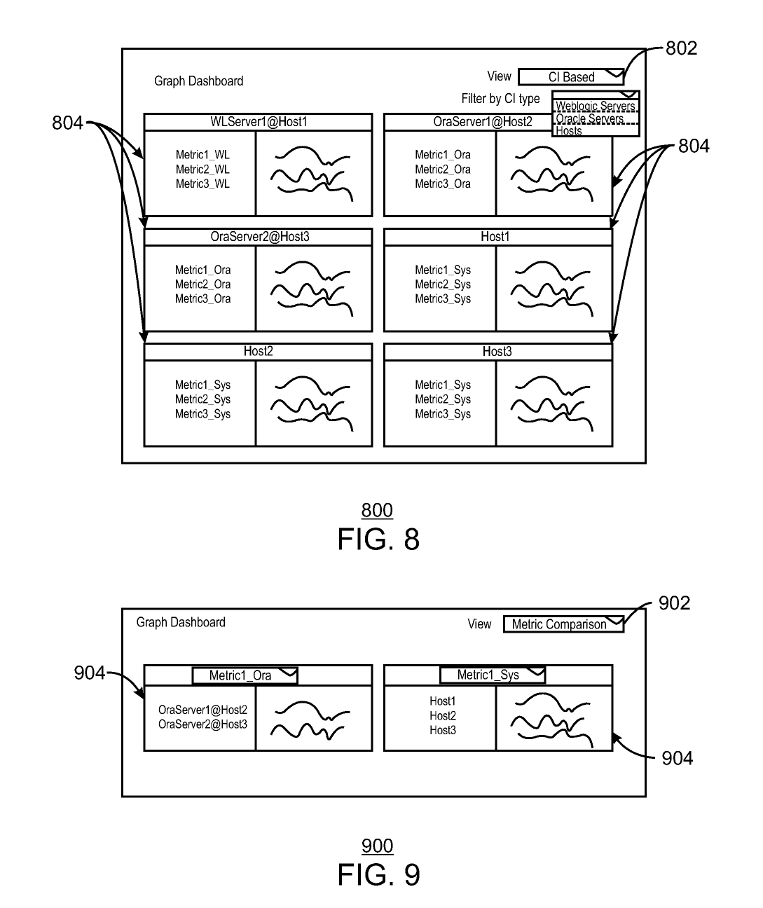

FIG. 8 is a screenshot 800 illustrating the visualization of metrics based on CI 802, in accordance with exemplary embodiments of the present invention. In this screenshot 800, the graphs 804 show metrics that are aggregated across CIs giving a global picture of the operation of the application environment. For example, Metric1_Ora, Metric2_Ora, and Metric3_Ora can each be aggregated between Ora Server1 and Ora Server2. Filtering, such as screening metrics by CI type, can be applied to metrics for a specific CI within a graph to explore that particular CI. Further, additional metrics within a CI type can be added and remove from a graph to assist in diagnosing a problem.

FIG. 9 is a screenshot 900 illustrating the visualization of a single metric 902 across multiple CIs, in accordance with exemplary embodiments of the present invention. The graphs 904 in this screenshot 900 may be used to identify the specific CI causing performance degradation in a particular parameter, such as storage space, transfer rate, and the like.

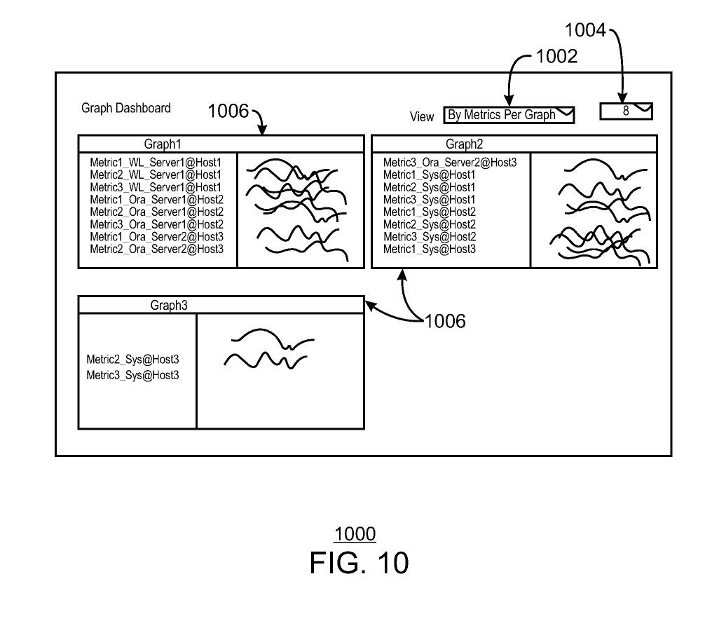

FIG. 10 is a screenshot 1000 illustrating the visualization of all of the metrics 1002, in accordance with an exemplary embodiment of the present invention. In this screenshot 1000, the number of metrics 1004 to show on each graph is selected (for example, eight). The number of graphs 1006 generated is controlled by the number of metrics per graph and the total number of metrics available. Since all of the metrics are displayed, the user may select a limited number of metrics to show on each graph to avoid complicating the analysis.

What is claimed is:

1. A method for visualizing a performance of a system, comprising:
generating a topological map of an application environment from a configuration management database (CMDB), wherein the topological map comprises a plurality of configuration items (CIs);
obtaining a selection of a configuration item (CI) from the plurality of CIs, wherein a CIType for the CI is identified from the CMDB;
obtaining a definition of a performance graph for the CIType from an operational database, wherein the performance graph is configured to simultaneously show performance metrics for the CI and related CIs;
accessing performance data for the CI and related CIs; and
generating the performance graph.

2. The method of claim 1, wherein the performance graph for a first CI of the identified CIType is different from a performance graph for a second CI of the identified CIType.

3. The method of claim 1, comprising:
accessing an updated topological map generated from the CMDB after the addition or removal of CIs; and
revising the definition of the performance graph to show the performance metrics of added CIs that are related to the CI or hide performance metrics of removed CIs that are related to the CI.

4. The method of claim 1, comprising:
revising the definition of the performance graph after relationships are created or deleted between CIs; and
generating a new performance graph that shows the performance metrics for the CI and the related CIs.

5. The method of claim 1, wherein selecting the CI is performed by choosing a desired CI from the topographical map.

6. The method of claim 1, wherein selecting the CI is performed by choosing a desired CI from a tree list.

7. The method of claim 1, wherein the topographical map comprises an indication of a relationship between the CI and the related CIs.

8. The method of claim 1, comprising defining the performance graph by selecting the performance parameters for the CI and the related CIs.

9. The method of claim 1, wherein the performance graph is automatically generated in response to an event.

10. The method of claim 1, wherein the performance metrics represent CPU utilization, memory usage, available disk space, response time, error count, time-out periods, or any combinations thereof.

11. The method of claim 1, comprising generating a graph dashboard comprising a plurality of performance graphs

12. The method of claim 11, wherein each of the plurality of performance graphs is filtered by CI type to show the performance of same types of CIs.

13. A system for visualizing a performance of a system, comprising:
a processor;
an output device; and
a computer readable medium comprising:
a configuration management database (CMDB) comprising a list of configuration items (CIs);
a topographical map of at least a portion of the CMDB;
a definition of a performance graph for a CIType for a CI on the topological map, wherein the performance graph is configured to provide an illustration of the performance of the CI and related CIs; and
code configured to direct the processor to read the definition of the performance graph, access stored performance data for the CI and the related CIs, and generate the performance graph.

14. The system of claim 13, wherein the CIs comprise clusters, hosts, storage servers, applications, databases, database tables, disk drives, or any combinations thereof.

15. The system of claim 13, comprising an operations management system.

16. The system of claim 13, comprising a distributed network application implemented across a plurality of servers, wherein the CMDB contains a list of the CIs that make up the distributed network application.

17. The system of claim 16, comprising agents located on each of the plurality of servers to collect performance data about the network application.

18. A tangible, computer readable medium, comprising:
a configuration management database (CMDB) comprising a list of configuration items (CIs);
a definition of a performance graph, wherein the performance graph is configured to provide an illustration of a performance of a CI and related CIs; and
code configured to direct a processor to read the definition of the performance graph, access stored performance data for the CI and the related CIs, and provide the performance graph on an output device.

19. The tangible, computer readable medium of claim 18, comprising a topological map of at least a portion of the CMDB.

20. The tangible, computer readable medium of claim 19, comprising code configured to update the topographical map upon the addition or removal of CIs.
